(19) United States
(12) Patent Application Publication
(10) Pub. No.: US 2024/0242221 A1
(43) Pub. Date: Jul. 18, 2024

(54) SYSTEMS AND METHODS FOR MULTI-FACTOR AUTHENTICATION USING DEVICE TRACKING AND IDENTITY VERIFICATION

(71) Applicant: Capital One Services, LLC, McLean, VA (US)

(72) Inventors: Jeffrey RULE, Chevy Chase, MD (US); Kevin OSBORN, Newton Highlands, MA (US); Wayne LUTZ, Fort Washington, MD (US)

(21) Appl. No.: 18/096,881

(22) Filed: Jan. 13, 2023

(51) Int. Cl. G06Q 20/40

(52) U.S. Cl. CPC G06Q 20/4015; G06Q 20/409

(57) ABSTRACT

Systems and methods are directed to a modified device configuration for disposing a NFC compatible user card within a NFC field of a user mobile device so as to enable continuous proximity monitoring based on a status of an NFC link established between the card and the mobile device. The modified device configuration may be utilized to implement card tracking functionality by using a mobile application, running on the mobile device, to generate a timestamp upon detection of change in a connectivity status of the NFC link to the card. The timestamp NFC connectivity data may then be paired with mobile device GPS coordinates, concurrently retrieved from one or more mobile GPS-based navigation applications, to facilitate card tracking functionality as well as multi-factor validation for electronic transactions initiated by the NFC compatible card and/or the mobile device.

### FIELD OF THE DISCLOSURE

The present disclosure is generally related to device proximity detection based on near field communication, and more specifically to the implementation of device tracking and identity verification functionalities based on device proximity detection for multi-factor authentication.

### BACKGROUND

Electronic transactions, initiated by a smart card and/or a mobile device application, generally involve a single factor of authentication based on verification of data stored on the card and/or transmitted in the transaction request message. With the ubiquity of smart phones, some authentication approaches have incorporated a secondary user device verification routine into the authentication process, by requiring a user to verify a card-initiated transaction via a corresponding user mobile device, as an additional security measure towards fraud prevention.

However, these approaches involve user-provided identification data inputted via a secondary device and are hampered by limited scope of authentication security. In addition, implementation that is contingent upon user-provided input authentication information may be sup-optimal for purposes of security and the user experience.

These are other deficiencies exist. Accordingly, there is a need for systems and methods implementing secure, user-friendly multi-factor authentication.

### SUMMARY OF THE DISCLOSURE

One aspect of the present disclosure is directed to an implementation of multi-factor transaction authentication based proximity monitoring of a user card by a mobile application. The process may be facilitated by an external card storage component which disposes the card within a Near Field Communication (NFC) field of a mobile device running a link monitoring and location tracking application. As such, one aspect of the proposed solution may be directed to a method comprising the step of: providing a mobile device associated with a user, with an external card pocket, structured to store a user card within a Near-Field communication (NFC) field of the mobile device, monitoring, by a user application stored on the mobile device, a connectivity status of an NFC link established between the user card, disposed in the card pocket, and the mobile device, generating one or more event timestamps associated with one or more detection events, wherein each detection event corresponds to a change in the connectivity status of the NFC link, comparing, by a validation process, a most recent event timestamp from the one or more event timestamps, with a transaction timestamp associated with a transaction request message for a transaction initiated by the user card, wherein the one or more event timestamps are transmitted to the validation process by the user application, verifying that the transaction timestamp does not exceed the most recent event timestamp by more than a predefined threshold value, wherein the most recent event timestamp corresponds to a removal of the card from the card pocket.

In accordance to some embodiments of the present disclosure, the method may further comprise recording a Global Positioning System (GPS) location coordinates corresponding to a GPS location of the mobile device, at each of the one or more event timestamp. The validation process may then generate a multi-factor strong transaction validation response based on the verification of a merchant location from a GPS location of the mobile device associated with the most recent event timestamp, and the comparison of the most recent event timestamp with the transaction timestamp.

One aspect of the present disclosure is directed to a system for implementing multi-factor transaction authentication based on device proximity monitoring and location tracking, the system comprising a structural element for storing a user card within a Near-Field communication (NFC) range of a mobile device running a user application, the system further comprising a computer hardware arrangement configure to: monitor, by the user application stored on the mobile device, a connectivity status of an NFC link established between the user card, when stored in the structural element, and the mobile device, generate one or more event timestamps associated with one or more detection events, wherein each detection event corresponds to a change in the connectivity status of the NFC link, compare, by a validation process, a most recent event timestamp from the one or more event timestamps, with a transaction timestamp associated with a transaction request message for a transaction initiated by the user card, wherein the one or more event timestamps are transmitted to the validation process by the user application. The system may then verify that the transaction timestamp does not exceed the most recent event timestamp by more than a predefined threshold value, wherein the most recent event timestamp corresponds to a removal of the card from the card pocket. Upon verifying that a time interval associated with the removal of the card from the card pocket does not exceed a predetermined threshold value, the system may generate a two-factor strong validation response for the transaction request message based on verifying proximity of the user card to the mobile device.

In accordance to some embodiments of the present disclosure, the system may further be configured to record a Global Positioning System (GPS) location coordinates corresponding to a GPS location of the mobile device, at each of the one or more event timestamp. The system may then generate a multi-factor strong transaction validation response based on the verification of a merchant location from a GPS location of the mobile device associated with the most recent event timestamp, and the comparison of the most recent event timestamp with the transaction timestamp.

One aspect of the present disclosure is directed to a non-transitory computer-accessible medium having stored thereon computer-executable instructions for implementing multi-factor transaction authentication based on card proximity and location tracking data.

### BRIEF SUMMARY OF THE DRAWINGS

FIG. 1A illustrates an exemplary interaction between a contactless card and a mobile device based on continuous short-range link monitoring, in accordance to some embodiments of the present disclosure.

FIG. 1B illustrates an exemplary structure with a card pocket arrangement for enabling interaction based on continuous short-range link monitoring, in accordance to some embodiments of the present disclosure.

FIG. 2A illustrates an exemplary modified device and device configuration for continuous card tracking implementation based on NFC link monitoring, in accordance to some embodiments of the present disclosure.

FIG. 2B illustrates an overview of an exemplary timestamping operation for generation of card tracking data, in accordance to some embodiments of the present disclosure.

FIG. 3 illustrates an embodiment of the modified device configuration for implementing multi-factor transaction authentication functionality, in accordance to some embodiments of the present disclosure.

FIG. 4 illustrates a flow chart for a process of using proximity event timestamping based on NFC link status monitoring to provide a two-factor strong transaction authentication capability, in accordance to some embodiments of the present disclosure.

FIG. 5 illustrates a flow chart for a process of using GPS location data in conjunction with NFC link status monitoring to provide a three-factor strong transaction authentication capability, in accordance to some embodiments of the present disclosure.

FIG. 6 is an illustration of an exemplary block diagram of an exemplary system, in accordance to some embodiments of the present disclosure.

### DETAILED DESCRIPTION

The following description of embodiments provides non-limiting representative examples referencing numerals to particularly describe features and teachings of different aspects of the invention. The embodiments described should be recognized as capable of implementation separately, or in combination, with other embodiments from the description of the embodiments. A person of ordinary skill in the art reviewing the description of embodiments should be able to learn and understand the different described aspects of the invention. The description of embodiments should facilitate understanding of the invention to such an extent that other implementations, not specifically covered but within the knowledge of a person of skill in the art having read the description of embodiments, would be understood to be consistent with an application of the invention.

In one aspect, the disclosed systems and methods aim to enhance the fraud prevention utility of contactless one time password (OTP) card transactions by including an addition layer of authentication security to the corresponding back-end validation process. The enhancement is facilitated by maintaining a continuous Near Filed Communication (NFC) contact between a mobile device and the contactless card using an external cardholder attached to the mobile device. This enables the mobile device to report the location of the card to a back-end validation process based on the detected status of the NFC link. The proposed arrangement comprises a mobile device with a cardholder pocket for storing a contactless OTP card within a NFC range of the mobile device reader which enables back-end tracking of the card activity with respect to its proximity with a secondary user device (e.g., the mobile phone). This provides a second factor of authentication for transaction conducted with the contactless OTP card without requiring a secondary authentication input from the user.

The disclosed physical arrangement and operational configuration for operating a contactless OTP card withing an NFC range of a mobile communication device (e.g., by using a cardholder pocket overlapping a communication field emanating from a reader of the mobile communication device) also provides active reporting of the card location based on an ON/OFF status of the NFC link, (e.g., corresponding to the insertion and removal of the card from the cardholder) which further provides a card tracking utility in case of a lost and/or stolen card.

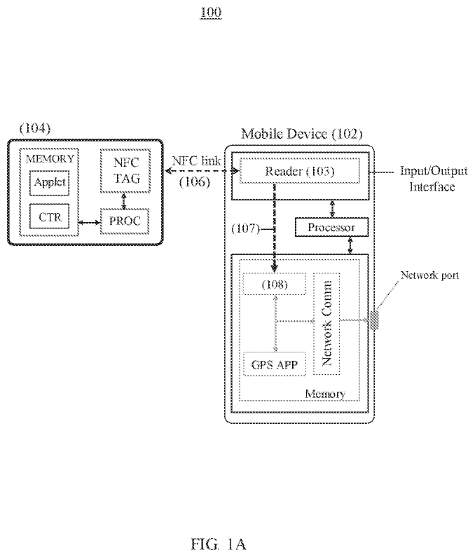

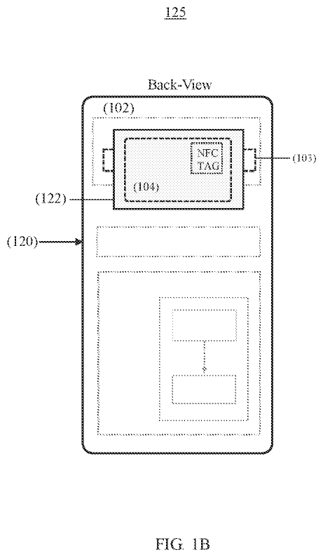

FIG. 1A illustrates an overview of the interaction between a mobile device (102) and a user card (104). The communication between the two devices (e.g., the mobile device (102) and the card (104)) is proximity-based and is enabled across a NFC link (106) which is established as the user card (104) enters an NFC field generated by, for example, the reader component (103) of the mobile device (102). An NFC tag on the user card may then communicate with the mobile device when in NFC proximity of the Mobile device reader. A corresponding user application (108) running on the mobile device may then receives and process the NFC transmitted data. The NFC field can be generated by a mobile device (e.g., a smartphone), a point-of-sale device, or other devices. The data (107) retrieved by the user application (108) may correspond to a connectivity status of the NFC link (106), which conveys either an active or an inactive status signifying that the card is present or not present within proximity of the mobile device (102).

FIG. 1B illustrates an exemplary back-view illustration (125) of a modified device (120) comprising a mobile device accessory, featuring a card storage compartment and/or pocket (e.g., card holder/storage component (122)) that stores an NFC-readable card (104) and may be utilized for operationally integrating the user mobile device (102) with the user card (104). For example, an active or inactive status of the NFC link (106) may signify that the card (104) is present or not present within the cardholder (122). A change in the connectivity status of the NFC link (106) from inactive to active may correspond to insertion of the user card (104) into the card pocket (122). Similarly a change in the NFC link status from active to inactive may correspond to removal of the user card (104) from the card pocket (122). The corresponding configuration may then be used to implement proximity monitoring/card tracking and multi-factor transaction authentication functionalities (e.g., for electronic transactions initiated by either the card or the mobile device.) In some embodiments, the card pocket may correspond to an external storage component affixed to the mobile device and structured to dispose the user card within a near-field communication (NFC) field of the mobile device. Accordingly, the (external) card storage component (also referred to as the card pocket) may be structurally configured to dispose the NFC tag of the user card (104) in an optimal orientation for establishing a proximity-based NFC link (106) with the NFC reader (103) of the mobile device (102). As shown in the exemplary back-view illustration (125) of the modified device (120) with the card holder/storage component (122), the user card (104), when stored in the card pocket (122), is oriented in such a way that the NFC tag of the card overlaps the NFC reader (103) of the mobile device (102). Accordingly, an active proximity-based NFC signal is established between the user card (104) (e.g., integrated NFC tag of the card) and the mobile device (102) (e.g., NFC reader component of the mobile device). The back-view (125) illustrate the overlay of the NFC tag with the mobile device NFC reader.

In some embodiments, the user card (104) stored in the card pocket (106), may correspond to a contactless card. The contactless card may comprise an integrated processor and memory that may store, for example, user identifying and/or authenticating information as near field communication (NFC) transmittable data (e.g., NFC Data Exchange Format (NDEF)). The integrated memory may store one or more applets that may be communicatively coupled to one or more applications (e.g. application 107) running on the user mobile and/or computing device (102) as well as one or more applications stored on a corresponding application server. The card-integrated memory may also store an application transaction counter (CTR) to keep track of a proper sequence of operations associated with a transaction conducted using the contactless card. The contactless card may further comprise a Near Field Communication (NFC) interface (e.g., NFC TAG) to facilitate NFC communication with an NFC reader (e.g., reader component (103) of the mobile device (102)). The user authentication information may then be directly captured by the reader component of the mobile user device by bringing the contactless card within an NFC range of the mobile device (e.g., by storing the contactless card in the card pocket (122) to overlay with the NFC reader (103) of the user mobile device) to, for example, initiate a direct read and subsequent validation of user authentication information stored, as NFC transmittable data, on the contactless card.

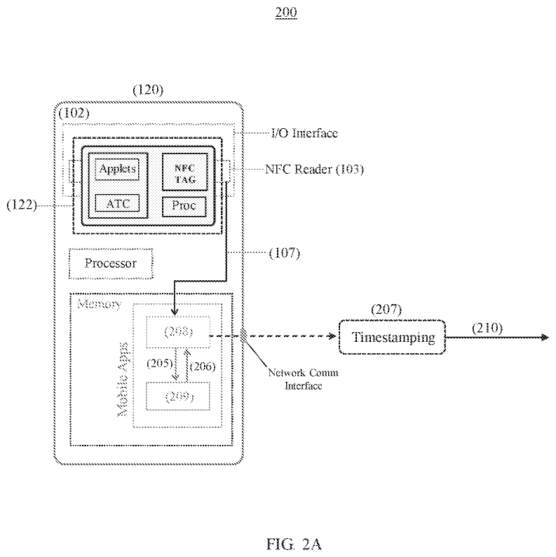

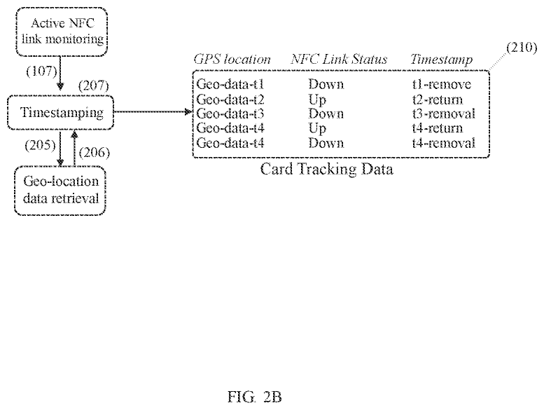

As described herein, one embodiment of the aforementioned configuration for operational integration of a user-card with one or more applications running on a mobile device, may be directed to a card tracking functionality as shown in FIG. 2A. As described with reference to FIG. 1, the mobile device (102) may maintain a continuous NFC link with the user card (104), as long the card remain within NFC field proximity of the mobile device. Accordingly, the exemplary card tracking configuration (200) comprising the modified device (120) with a card pocket (122), enables an active and/or continuous monitoring of the NFC link (106) by positioning the card in an orientation relative to the NFC reader (103) of the mobile device that optimize the NFC connectivity between the card and the mobile device. Upon removal of the card from the card pocket (122), the NFC link (106) is broken. A detection event corresponding to a change in a status of the NFC link (106) maybe used, by a mobile user application (208), to trigger a set of response such as generation of a timestamp, indicating a time for the change in the status of the NFC link, and retrieval of geolocation data, indicating the location coordinates of the mobile device (102) at the time of the change. The geolocation data may be retrieved from one or more GPS and/or navigation related application running on the mobile device. This is illustrated in example (200), by the location request (205) and location response (206) messages exchanged between the (card tracking) user application (208) and a GPS application (209) stored on the mobile device.

Card proximity detection based on active/passive NFC link status monitoring may correspond to detection of two discrete conditions corresponding to detection of a NFC link loss upon removal of the user card (104) from the card-pocket (122) and detection of an active NFC link established upon insertion/re-insertion of the card (104) into the card-pocket (122). The NFC link monitoring data, communicating a connectivity status of the NFC link, is transmitted by and/or retrieved from the NFC reader (103) of the mobile device (102) as indicated by the data transfer action (107). Upon receiving the NFC link status data, an exemplary timestamping operation (207), may be carried out by the user mobile application (208), for generating the card tracking data (210) as further illustrated in FIG. 2B.

FIG. 2B illustrated an exemplary overview of a timestamping operation (207) which may involve generating a timestamp for each detection event corresponding to a change in the connectivity status of the NFC link (106), detected by user application the (208), based on the active NFC link monitoring data (107) from the NFC reader. The operation may further involve a location data request message (205) and a retrieval of geolocation data (206) corresponding to the location of the mobile device, as provided by one or more mobile GPS-based application (209). As described herein, the aforementioned location data communication may be initiated upon the detection of a NFC link status event. The timestamped NFC link status data and corresponding GPS location data (206) may then be compiled into one or more data structures as shown by the exemplary card tracking datasets (210). The card tracking data (210) may then be stored by the mobile device and/or communicated to a remote validation server to facilitate card tracking and/or multi-factor authentication functionalities.

In some embodiments the card tracking data may be used to identify a lost card situation and a user notification may be provided via, for example the user mobile device. In such situation there may be a pre-defined window of time during which a loss of NFC link may be attributed to temporary removal of the card from the card pocket for the purpose of conducting a transaction. As such a lost card notification may be generated by a card tracking application (e.g., 208) based on a determination that a timelapse associated with the most recent event timestamp exceeds the predefined threshold value. A notification may then be generated and communicated to the user with a timestamp corresponding to the last recorded location of the card based on GPS reading on the mobile device, with the most recent GPS location of the mobile device corresponding to the most recently recorded timestamp. The aforementioned threshold (time-window) value may be specified by the user or determined by the system and/or the user (mobile) application based on historical geo-tracking and card proximity data. In some embodiments.

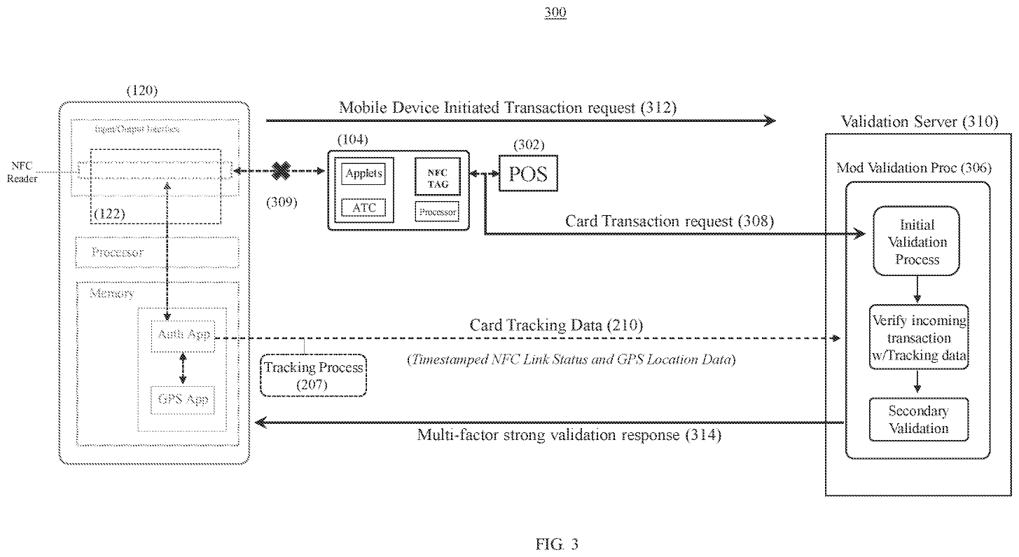

FIG. 3 illustrate an exemplary embodiment of the device (120), utilizing the card pocket structure (122), in implementing a (modified) transaction authentication process (306) for electronic transactions conducted with the card (104) and, for example, a Point Of Sale (POS) device (302) located at a merchant location. In some embodiment, transaction request (308) may correspond to an electronic card transaction conducted remotely via, for example, a merchant website. The aforementioned embodiments provide a fraud prevention functionality for electronic transaction involving the modified device (120) by confirming a presence of a distinct secondary user device in proximity of the transaction initiating user device.

In some embodiments the card tracking data (comprising timestamped NFC link status and GPS location data) generated based on the modified device (120), may be used to enable a multi-factor authentication of electronic transaction conducted by the user card (104) and/or the mobile device (102). In such situation there may be a pre-defined window of time during which a loss of NFC link may be attributed to temporary removal of the card from the card pocket for the purpose of conducting a transaction. As such a second-factor validation parameter may be based on a determination that a timelapse between the most recent event timestamp and reception, by the validation server (310), of an incoming card transaction request (308), does not exceeds the predefined threshold value, thereby establishing the proximity of the user card (104) to a second user device (e.g., mobile device (102)). The threshold (time-window) value may be specified by the user or determined by the system and/or the user (mobile) application based on historical geo-tracking and card proximity data.

Referring back to FIG. 3, a time period lapsed between a card-removal event (309) corresponding to the most recent event timestamp (e.g., t4-removal with respect to card tracking data (210)) and the reception of a transaction request message (308) by the validation server (310) may be calculated and compared with the aforementioned threshold time-window by the modified validation process (306) running on the receiving validation server (310). If the removal time window (309), based on the most recent event timestamp, for example as received via dataset (210), and detection of the transaction request message (308) by the validation server (310) does not exceed the threshold time-window value, a two-factor strong validation response may be generated for the electronic transaction request message (308). In some embodiments, upon determining that an incoming transaction timestamp exceeds the most recent event timestamp, by more than the predefined threshold value, a notification may be generated and communicated to the user. The notification may further comprise a timestamp corresponding to the last recorded location of the card based on GPS reading on the mobile device. Accordingly, the validation of the transaction request may be suspended pending reception of a user confirmation signal via the mobile device (102).

Another embodiments associated with system implementation (300) may corresponds to a multi-factor authentication for an electronic transaction request (e.g., transaction request (312)) initiated by the mobile device (102). With reference to the mobile device initiated transaction request message (312), the proximity information to a secondary user device (e.g., card (104)) may be communicated, via the card tracking data, along with other user and/or account identifying information to enhance a security of the authentication process against fraudulent electronic transactions that may, for example, be attempted with stolen user and/or account identifying information. The card proximity information (transmitted in the card tracking data) may be provided as an additional factor of authentication. As such upon receiving the online transaction request (312), a two-factor strong verification process may be performed by the modified validation process (306), the two-factor strong verification process being based on a determination that the transaction timestamp, associated with the online transaction, does not exceed the most recent event timestamp in the card tracking data (210), by more than the predefined threshold value. Upon determining that the transaction timestamp exceeds the most recently recorded event timestamp, by more than the predefined threshold value, a user alert notification may be generated by the user application running on the mobile device.

With reference to the exemplary embodiment (300), further enhancement of authentication security may be achieved by using the GPS location data for geo-identification of a merchant location associated with an incoming transaction request (e.g., card transaction request (308) and/or mobile device initiated transaction request (312)). The modified validation process (306) may then identify a merchant based on the GPS location data provided in the card tracking data (210) and compare merchant identifying data (determined based on the reported GPS location) with one or more merchant identifiers extracted from the transaction string data (e.g., corresponding to transaction request (308) and/or (312)). The geo-identification of the merchant based on the GPS location data recorded in the card tracking data and verification of the corresponding card proximity data relative to the predefined threshold value may be used by the modified verification process (306) to generate, a multi-factor strong validation message (314) corresponding to three factors of identity verification, in response to the incoming transaction request.

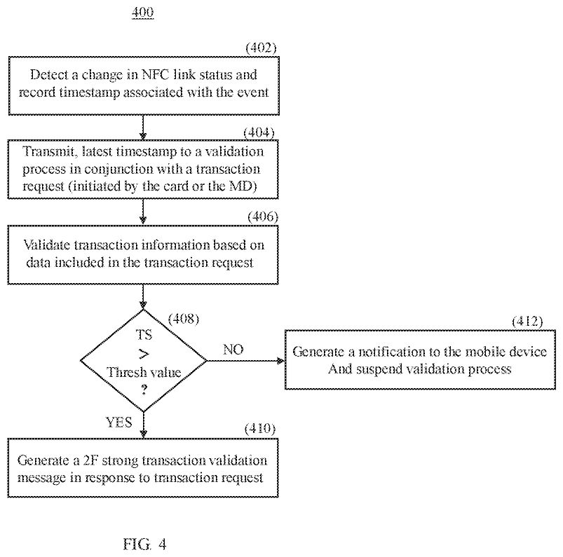

FIG. 4 illustrates an exemplary operational flow for implementing a two-factor authentication of electronic transactions based on modified device configuration (120). The operational flow diagram (400) may apply to electronic transactions initiated by either the user card (104) and/or the mobile device (102) associated with the modified device configuration (120). The basis of the implementation is to verify the proximity of another device (without requiring an additional action by the user) using out of band (OOB) transmission of card proximity data to a transaction validation server. The card proximity data may then be used in validation of a transaction request message initiated by either of the devices associated with the modified device configuration (120) (e.g., user card and/or user mobile device). Referring back to FIG. 4, at step (402), the exemplary process flow (400) may detect a change in the NFC link status established between the user card and the mobile device and generate an event timestamps in response to detected event corresponding to a link up or a link down condition. At step (404), upon detection of link down status an application running on the mobile device may transmit, the timestamp indicating a change in the NFC link status.

A validation process receiving an electronic transaction validation request, may validate the electronic transaction string based on data provided in the transaction message (step 406). Upon authenticating the transaction request string, the validation process may further analyze the out of band data (e.g., data received in association with and/or in conjunction to the electronic transaction that was not included in the initial transaction string) to confirm, based on card-proximity timestamps, that the period of time the card has been away from the card pocket does not exceed a predetermined Threshold value. Once the card-mobile device proximity at least for a period of time corresponding to the predefined threshold value has been determined at step (408), a two-factor strong transaction validation message may be generated and transmitted back in response to the transaction request, at step (410). Conversely, if it is determined, at step (408), that the card-removal timestamp exceeds the threshold value, indicating extended period of separation between the user card and the mobile device, the process may move onto step (412) wherein a notification may be transmitted to the mobile device and the validation process declined and/or suspended pending reception of a user confirmation response from the mobile device.

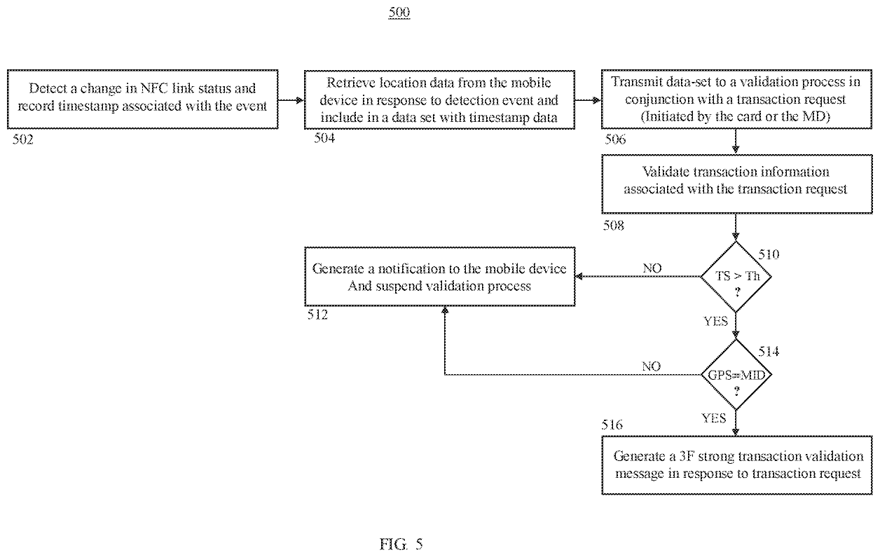

FIG. 5 illustrates an exemplary operational flowchart (500) for implementing a multi-factor authentication with the modified device (120), based on verification of timestamped NFC link status and GPS location data in correspondence to an electronic transaction initiated by either the user card (104) or the mobile device (102). The transaction may be initiated by the mobile device using for example a mobile application with authentication functionality, such as a banking application and/or an authentication application stored on the mobile device. The transaction may also be initiated by the user card by removing the card from the designated card pocket (attached to the mobile device and tap or swiping it at a POS) device. A card transaction may also correspond to entering the card information along with any card and/or user authentication data into an online payment interface of a merchant website for conducting an online transaction. In such cases, verification of proximity to a secondary user device may serve as a second identification factor for authenticating the electronic transaction as previously discussed with reference to FIGS. 3 and 4. As further discussed with reference to FIG. 3, a multi-factor authentication scheme may also be implemented based on the modified device configuration (120). FIG. 5 illustrates a operational flow diagram for an exemplary three-factor transaction authentication scheme (500) using three factor of identity authentication based on timestamped NFC link status data (to verify proximity with a secondary user device) and GPS location data as provided by the card tracking data (to verify a transacting merchant location against merchant identifying information extracted from an incoming transaction request string)

Referring back to FIG. 5, step (502) corresponds to detection of a NFC link status change and generation of a timestamp associated with the link status event. At step (504), data from a mobile GPS application may be retrieved to determine a physical location of the modified device at transaction time. The operation at step (504) may occur concurrent or consecutive to the generation of the timestamp indicating a link change status at step (502). The retrieved GPS location data and the (link loss) timestamp may be included in a card tracking dataset (step 504). At step (506), the data step generated in step (504) may be provided, by the mobile authentication application for example, to a validation process in conjunction with a transaction request initiated by either the user card (104) or the mobile device(102).

The validation process receiving the transaction request and the card tracking dataset, may first validate the electronic transaction string based on authentication and/or account data provided in the transaction message (step 508). This step may also correspond to the action associated with step (406) in FIG. 4. Upon authenticating the transaction request string, the validation process may move to step (510) for verifying proximity data relative to a second user device, based on information provided in the card tracking dataset. If the proximity data relative to the second user device is not available for a period exceeding the predefined threshold value, indicating an extended period of separation between the card and the phone, one or more action may be initiated by the validation process as indicated by step (512). The one or more actions may comprise, for example, generating a notification to the mobile device to alert a user and/or suspending the validation of the transaction request pending, for example, a receipt of a user confirmation signal from the mobile device. However, if the proximity data relative to the second user device is verified at step (510), the process may move onto step (514).

At step (514), the card tracking dataset may be further examined to confirm that the corresponding timestamped GPS location data matches a location of the merchant identified from the transaction request string. If a match is not identified, the one or more actions associated with step (512) may be performed. However, if the GPS location data matches merchant information extracted from the transaction string at step (514), a multi-factor strong validation response (e.g., corresponding to a verification of a secondary device proximity and the transaction-initiation location) may be generated in response to the transaction request message.

In some embodiments, one or more of the forementioned computations and operation, for card tracking and providing multiple factors of authentication based on dynamic NFC link status and mobile GPS location data, may be executed, in part or in whole, by one or more applications running on the user mobile device and/or one or more server-side applications running on a corresponding remote validation server communicatively coupled to the one or more user application running on the user mobile device across a network.

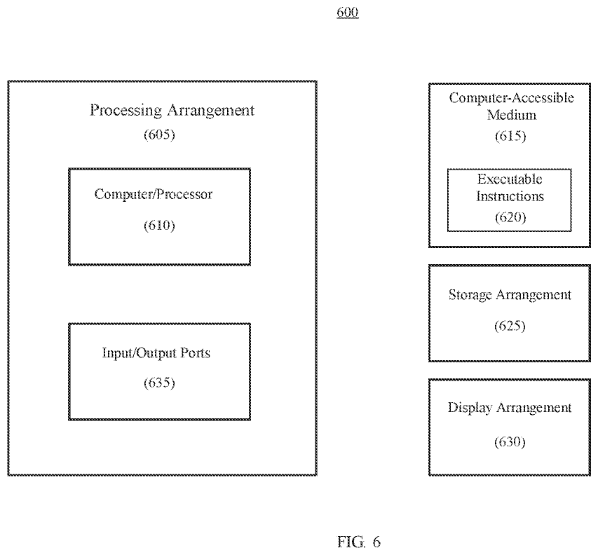

FIG. 6 shows a block diagram of an exemplary embodiment of a system according to the present disclosure. For example, exemplary procedures in accordance with the present disclosure described herein can be performed by a processing arrangement and/or a computing arrangement (e.g., computer hardware arrangement) (605). Such processing and/or computing arrangement (605) can be, for example entirely or a part of, or include, but not limited to, a computer and/or processor (610) that can include, for example one or more microprocessors, and use instructions stored on a computer-accessible medium (e.g., RAM, ROM, hard drive, or other storage device).

As shown in FIG. 6, for example a computer-accessible medium (615) (e.g., as described herein above, a storage device such as a hard disk, floppy disk, memory stick, CD-ROM, RAM, ROM, etc., or a collection thereof) can be provided (e.g., in communication with the processing arrangement (605)). The computer-accessible medium (615) can contain executable instructions (620) thereon. In addition or alternatively, a storage arrangement (625) can be provided separately from the computer-accessible medium (615), which can provide the instructions to the processing arrangement (605) so as to configure the processing arrangement to execute the exemplary procedures, processes, and methods, as described herein above, for example.

Further, the exemplary processing arrangement (605) can be provided with or include an input and/or output ports (635), which can include, for example a wired network, a wireless network, the internet, an intranet, a data collection probe, a sensor, etc. As shown in FIG. 6, the exemplary processing arrangement (605) can be in communication with an exemplary display arrangement (630), which, according to certain exemplary embodiments of the present disclosure, can be a touch-screen configured for inputting information to the processing arrangement in addition to outputting information from the processing arrangement, for example. Further, the exemplary display arrangement (630) and/or a storage arrangement (625) can be used to display and/or store data in a user-accessible format and/or user-readable format.

In some aspects, the techniques described herein relate to a method for incorporating device proximity monitoring in multi-factor authentication, the method including: providing a mobile device associated with a user, with an external card pocket, structured to store a user card within a Near-Field communication (NFC) field of the mobile device; monitoring, by a user application stored on the mobile device, a connectivity status of an NFC link established between the user card, disposed in the card pocket, and the mobile device; generating one or more event timestamps associated with one or more detection events, wherein each detection event corresponds to a change in the connectivity status of the NFC link; comparing, by a validation process, a most recent event timestamp from the one or more event timestamps, with a transaction timestamp associated with a transaction request message for a transaction initiated by the user card, wherein the one or more event timestamps are transmitted to the validation process by the user application; verifying that the transaction timestamp does not exceed the most recent event timestamp by more than a predefined threshold value, wherein the most recent event timestamp corresponds to a removal of the card from the card pocket; and generating a two-factor strong validation response for the transaction request message based on verifying proximity of the user card to the mobile device.

In some aspects, the techniques described herein relate to a method, further including recording a Global Positioning System (GPS) location coordinates corresponding to a GPS location of the mobile device, at each of the one or more event timestamps.

In some aspects, the techniques described herein relate to a method, wherein a most recent GPS location of the mobile device corresponds to the most recently recorded timestamp.

In some aspects, the techniques described herein relate to a method, further including, verifying, by the validation process, that the most recent GPS location of the mobile device corresponds to a merchant location identified from the transaction request message.

In some aspects, the techniques described herein relate to a method, further including, generating, by the validation process, a multi-factor strong validation response corresponding to a verification of a merchant location based on verification of the most recent GPS location of the mobile device and the most recent event timestamp.

In some aspects, the techniques described herein relate to a method, wherein the user application includes one or more application components running on a remote validation server associated with the validation process.

In some aspects, the techniques described herein relate to a method, wherein the predetermined threshold value is specified by the user.

In some aspects, the techniques described herein relate to a method, wherein the transaction request message corresponds to an online transaction initiated from the mobile device.

In some aspects, the techniques described herein relate to a method, wherein, upon receiving the online transaction request, a two-factor strong verification process is performed by the validation process, the two-factor strong verification process being based on a determination that the transaction timestamp, associated with the online transaction, does not exceed the most recent event timestamp by more than the predefined threshold value.

In some aspects, the techniques described herein relate to a method, further including generating, upon determining that the transaction timestamp exceeds the most recent event timestamp, by more than the predefined threshold value, a user alert notification by the user application running on the mobile device.

In some aspects, the techniques described herein relate to a method, wherein the user alert notification includes a most recent GPS location of the user card corresponding to the most recent event timestamp.

In some aspects, the techniques described herein relate to a method, wherein the monitoring correspond to determining the connectivity status of NFC link as active or inactive.

In some aspects, the techniques described herein relate to a method, wherein a change in the connectivity status of the NFC link from inactive to active corresponds to an insertion of the user card into the card pocket for storage, and a change in the status of the NFC link from inactive to active corresponds to a removal of the user card from the card pocket for conducting an electronic transaction.

In some aspects, the techniques described herein relate to a system for implementing multi-factor transaction authentication based on device proximity monitoring, the system including a structural element for storing a user card within a Near-Field communication (NFC) range of a mobile device running a user application, the system further including a computer hardware arrangement configure to: monitor, by the user application stored on the mobile device, a connectivity status of an NFC link established between the user card, when stored in the structural element, and the mobile device; generate one or more event timestamps associated with one or more detection events, wherein each detection event corresponds to a change in the connectivity status of the NFC link; compare, by a validation process, a most recent event timestamp from the one or more event timestamps, with a transaction timestamp associated with a transaction request message for a transaction initiated by the user card, wherein the one or more event timestamps are transmitted to the validation process by the user application; verify that the transaction timestamp does not exceed the most recent event timestamp by more than a predefined threshold value, wherein the most recent event timestamp corresponds to a removal of the card from the card pocket; and generate a two-factor strong validation response for the transaction request message based on verifying proximity of the user card to the mobile device.

In some aspects, the techniques described herein relate to a system, wherein the computer hardware arrangement configure to record a Global Positioning System (GPS) location coordinates corresponding to a GPS location of the mobile device, at each of the one or more event timestamps.

In some aspects, the techniques described herein relate to a system, wherein the hardware arrangement is further configured to verify, if a GPS location data associated with the most recent event timestamp corresponds to a merchant location identified from the transaction request message.

In some aspects, the techniques described herein relate to a system, wherein the hardware arrangement is further configured to generate a multi-factor strong validation response corresponding to a validation of a merchant location based on verification of the most recent GPS location of the mobile device, and the most recent event timestamp.

In some aspects, the techniques described herein relate to a non-transitory computer-accessible medium including instructions for execution by a computer hardware arrangement, wherein upon execution of the instructions the computer hardware arrangement is configured to perform procedures including: monitoring, by a user application stored on the mobile device, a connectivity status of an NFC link established between a user card and a mobile device, wherein the user card is stored in an external storage component affixed to the mobile device and structured to dispose the user card within a Near-Field communication (NFC) field of the mobile device; generating one or more event timestamps associated with one or more detection events, wherein each detection event corresponds to a change in the connectivity status of the NFC link; comparing, by a validation process, a most recent event timestamp from the one or more event timestamps, with a transaction timestamp associated with a transaction request message for a transaction initiated by the user card, wherein the one or more event timestamps are transmitted to the validation process by the user application; verifying that the transaction timestamp does not exceed the most recent event timestamp by more than a predefined threshold value, wherein the most recent event timestamp corresponds to a removal of the card from the card pocket; and generating a two-factor strong validation response for the transaction request message based on verifying proximity of the user card to the mobile device.

In some aspects, the techniques described herein relate to a non-transitory computer-accessible medium, further including instructions to record a Global Positioning System (GPS) location coordinates corresponding to a GPS location of the mobile device, at each of the one or more event timestamps.

In some aspects, the techniques described herein relate to a non-transitory computer-accessible medium, further including instructions to verify, if a GPS location data associated with the most recent event timestamp corresponds to a merchant location identified from the transaction request message.

As used herein, the term “card” is not limited to a particular type of card. Rather, it is understood that the term “card” can refer to a contact-based card, a contactless card, or any other card, unless otherwise indicated. It is further understood that the present disclosure is not limited to cards having a certain purpose (e.g., payment cards, gift cards, identification cards, membership cards, transportation cards, access cards), to cards associated with a particular type of account (e.g., a credit account, a debit account, a membership account), or to cards issued by a particular entity (e.g., a commercial entity, a financial institution, a government entity, a social club). Instead, it is understood that the present disclosure includes cards having any purpose, account association, or issuing entity.

The present disclosure is not to be limited in terms of the particular embodiments described in this application, which are intended as illustrations of various aspects. Many modifications and variations can be made without departing from its spirit and scope, as may be apparent. Functionally equivalent methods and apparatuses within the scope of the disclosure, in addition to those enumerated herein, may be apparent from the foregoing representative descriptions. Such modifications and variations are intended to fall within the scope of the appended representative claims. The present disclosure is to be limited only by the terms of the appended representative claims, along with the full scope of equivalents to which such representative claims are entitled. It is also to be understood that the terminology used herein is for the purpose of describing particular embodiments only, and is not intended to be limiting.

It is further noted that the systems and methods described herein may be tangibly embodied in one of more physical media, such as, but not limited to, a compact disc (CD), a digital versatile disc (DVD), a floppy disk, a hard drive, read only memory (ROM), random access memory (RAM), as well as other physical media capable of data storage. For example, data storage may include random access memory (RAM) and read only memory (ROM), which may be configured to access and store data and information and computer program instructions. Data storage may also include storage media or other suitable type of memory (e.g., such as, for example, RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives, any type of tangible and non-transitory storage medium), where the files that comprise an operating system, application programs including, for example, web browser application, email application and/or other applications, and data files may be stored. The data storage of the network-enabled computer systems may include electronic information, files, and documents stored in various ways, including, for example, a flat file, indexed file, hierarchical database, relational database, such as a database created and maintained with software from, for example, Oracle® Corporation, Microsoft® Excel file, Microsoft® Access file, a solid state storage device, which may include a flash array, a hybrid array, or a server-side product, enterprise storage, which may include online or cloud storage, or any other storage mechanism. Moreover, the figures illustrate various components (e.g., servers, computers, processors, etc.) separately. The functions described as being performed at various components may be performed at other components, and the various components may be combined or separated. Other modifications also may be made.

In the preceding specification, various embodiments have been described with references to the accompanying drawings. It will, however, be evident that various modifications and changes may be made thereto, and additional embodiments may be implemented, without departing from the broader scope of the invention as set forth in the claims that follow. The specification and drawings are accordingly to be regarded as an illustrative rather than restrictive sense.

1. A method for incorporating device proximity monitoring in multi-factor authentication, the method comprising:
providing a mobile device associated with a user, with an external card pocket, structured to store a user card within a Near-Field communication (NFC) field of the mobile device;
monitoring, by a user application stored on the mobile device, a connectivity status of an NFC link established between the user card, disposed in the card pocket, and the mobile device;
generating one or more event timestamps associated with one or more detection events, wherein each detection event corresponds to a change in the connectivity status of the NFC link;
comparing, by a validation process, a most recent event timestamp from the one or more event timestamps, with a transaction timestamp associated with a transaction request message for a transaction initiated by the user card, wherein the one or more event timestamps are transmitted to the validation process by the user application;
verifying that the transaction timestamp does not exceed the most recent event timestamp by more than a predefined threshold value, wherein the most recent event timestamp corresponds to a removal of the card from the card pocket; and
generating a two-factor strong validation response for the transaction request message based on verifying proximity of the user card to the mobile device.

2. The method of claim 1, further comprising recording a Global Positioning System (GPS) location coordinates corresponding to a GPS location of the mobile device, at each of the one or more event timestamps.

3. The method of claim 2, wherein a most recent GPS location of the mobile device corresponds to a most recently recorded timestamp.

4. The method of claim 3, further comprising, verifying, by the validation process, that the most recent GPS location of the mobile device corresponds to a merchant location identified from the transaction request message.

5. The method of claim 4, further comprising, generating, by the validation process, a multi-factor strong validation response corresponding to a verification of a merchant location based on verification of the most recent GPS location of the mobile device and the most recent event timestamp.

6. The method of claim 1, wherein the user application comprises one or more application components running on a remote validation server associated with the validation process.

7. The method of claim 1, wherein the predefined threshold value is specified by the user.

8. The method of claim 1, wherein the transaction request message corresponds to an online transaction initiated from the mobile device.

9. The method of claim 8, wherein, upon receiving the online transaction request, a two-factor strong verification process is performed by the validation process, the two-factor strong verification process being based on a determination that the transaction timestamp, associated with the online transaction, does not exceed the most recent event timestamp by more than the predefined threshold value.

10. The method of claim 1, further comprising generating, upon determining that the transaction timestamp exceeds the most recent event timestamp, by more than the predefined threshold value, a user alert notification by the user application running on the mobile device.

11. The method of claim 10, wherein the user alert notification includes a most recent GPS location of the user card corresponding to the most recent event timestamp.

12. The method of claim 1, wherein the monitoring correspond to determining the connectivity status of NFC link as active or inactive.

13. The method of claim 12, wherein a change in the connectivity status of the NFC link from inactive to active corresponds to an insertion of the user card into the card pocket for storage, and a change in the status of the NFC link from inactive to active corresponds to a removal of the user card from the card pocket for conducting an electronic transaction.

14. A system for implementing multi-factor transaction authentication based on device proximity monitoring, the system comprising a structural element for storing a user card within a Near-Field communication (NFC) range of a mobile device running a user application, the system further comprising a computer hardware arrangement configure to:
monitor, by the user application stored on the mobile device, a connectivity status of an NFC link established between the user card, when stored in the structural element, and the mobile device;
generate one or more event timestamps associated with one or more detection events, wherein each detection event corresponds to a change in the connectivity status of the NFC link;
compare, by a validation process, a most recent event timestamp from the one or more event timestamps, with a transaction timestamp associated with a transaction request message for a transaction initiated by the user card, wherein the one or more event timestamps are transmitted to the validation process by the user application;
verify that the transaction timestamp does not exceed the most recent event timestamp by more than a predefined threshold value, wherein the most recent event timestamp corresponds to a removal of the card from the structural element; and
generate a two-factor strong validation response for the transaction request message based on verifying proximity of the user card to the mobile device.

15. The system of claim 14, wherein the computer hardware arrangement configure to record a Global Positioning System (GPS) location coordinates corresponding to a GPS location of the mobile device, at each of the one or more event timestamps.

16. The system of claim 15, wherein the hardware arrangement is further configured to verify, if a GPS location data associated with the most recent event timestamp corresponds to a merchant location identified from the transaction request message.

17. The system of claim 16, wherein the hardware arrangement is further configured to generate a multi-factor strong validation response corresponding to a validation of a merchant location based on verification of the most recent GPS location of the mobile device, and the most recent event timestamp.

18. A non-transitory computer-accessible medium comprising instructions for execution by a computer hardware arrangement, wherein upon execution of the instructions the computer hardware arrangement is configured to perform procedures comprising:
monitoring, by a user application stored on a mobile device, a connectivity status of an NFC link established between a user card and the mobile device, wherein the user card is stored in an external storage component affixed to the mobile device and structured to dispose the user card within a Near-Field communication (NFC) field of the mobile device;
generating one or more event timestamps associated with one or more detection events, wherein each detection event corresponds to a change in the connectivity status of the NFC link;
comparing, by a validation process, a most recent event timestamp from the one or more event timestamps, with a transaction timestamp associated with a transaction request message for a transaction initiated by the user card, wherein the one or more event timestamps are transmitted to the validation process by the user application;
verifying that the transaction timestamp does not exceed the most recent event timestamp by more than a predefined threshold value, wherein the most recent event timestamp corresponds to a removal of the card from the external storage component; and
generating a two-factor strong validation response for the transaction request message based on verifying proximity of the user card to the mobile device.

19. The non-transitory computer-accessible medium of claim 18, further comprising instructions to record a Global Positioning System (GPS) location coordinates corresponding to a GPS location of the mobile device, at each of the one or more event timestamps.

20. The non-transitory computer-accessible medium of claim 19, further comprising instructions to verify, if a GPS location data associated with the most recent event timestamp corresponds to a merchant location identified from the transaction request message.
